(19) United States
(12) Patent Application Publication
(10) Pub. No.: US 2026/0124933 A1
(43) Pub. Date: May 7, 2026

(54) SYSTEMS AND METHODS FOR PERFORMING EXTENDED RANGE ELECTRIC VEHICLE SMART REMOTE CHARGING

(71) Applicants: Hyundai Motor Company, Seoul (KR); Kia Corporation, Seoul (KR)

(72) Inventors: Tucker Biallas, Superior Township, MI (US); Peter J. Richmond, Superior Township, MI (US); Dokyung Yim, Hwaseong (KR); Jason Lee, Superior Township, MI (US)

(21) Appl. No.: 18/936,713

(22) Filed: Nov. 4, 2024

(51) Int. Cl. B60L 50/62; B60L 53/30; B60L 53/62

(52) U.S. Cl. CPC B60L 50/62; B60L 53/62; B60L 53/305; B60L 2260/28; B60L 2260/52

(57) ABSTRACT

Systems and methods for performing smart remote charging of an extended range electric vehicle (EREV) are provided. The method may comprise receiving, using a computing device, one or more vehicle data inputs from an EREV. The EREV may comprise a battery, one or more onboard motor generator units (MGUs), and a power generation unit configured to charge the battery, utilizing the one or more MGUs, and the computing device, comprising a processor, memory, and user interface. The method may comprise determining, using the processor, whether there is an opportunity to charge the EREV, when there is an opportunity to charge the EREV, notifying, using the graphical user interface, a user of the opportunity and suggest one or more user commands for charging the vehicle, receiving one or more user commands, and, based on the one or more user commands, performing one or more charging functions of the EREV.

### BACKGROUND

### Technical Field

Embodiments of the present disclosure relate to systems and methods for performing extended range electric vehicle (EREV) smart remote charging.

### BACKGROUND

Electric vehicles (EVs) comprise one or more batteries configured to power the EV and enable it to move. These batteries draft after use and over time and require charging. Typically, a charging cable is coupled to the EV, supplying power to charge the EV's battery or batteries. This process requires the cable to physically connect the charging port of the vehicle to the power supply.

An extended range electric vehicle (EREV) is an EV that utilizes an onboard internal combustion engine (ICE) to charge a high voltage (HV) battery of the EREV but not power the wheels. When the battery state of charge (SOC) is low, the ICE will charge the battery utilizing an onboard motor generator unit (MGU). However, due to the unique cost-efficient layout of the ICE and motors, the EREV loses all wheel drive (AWD) functionality while the battery is charging since, when the front motor is utilized for charging, the EREV disconnects the motor via a clutch from torque output to the wheels

### SUMMARY

According to an object of the present disclosure, a method for performing smart remote charging of an extended range electric vehicle (EREV) is provided. The method may comprise receiving, using a computing device, one or more vehicle data inputs from an EREV. The EREV may comprise a battery, one or more onboard motor generator units (MGUs), and a power generation unit such as an internal combustion engine (ICE) configured to charge the battery, utilizing the one or more MGUs, and the computing device, comprising a processor, and a memory.

The EREV may be configured to perform using all wheel drive (AWD) when the battery is not charging, and not perform AWD when the battery is charging. The method may comprise determining, using the processor, whether there is an opportunity to charge the EREV, when there is an opportunity to charge the EREV, notifying, using the graphical user interface, a user of the opportunity and suggest one or more user commands for charging the vehicle, receiving one or more user commands, and, based on the one or more user commands, performing one or more charging functions of the EREV.

In one aspect, a method is provided for performing smart remote charging of an extended range electric vehicle (EREV), comprising: a) receiving, using a computing device, one or more vehicle data inputs from an EREV, the EREV comprising: i) a battery; ii) one or more onboard motor generator units (MGUs); iii) a power generation unit configured to charge the battery, utilizing the one or more MGUs; and iv) the computing device, comprising a processor and a memory; b) determining, using the processor, whether there is an opportunity to charge the EREV; when there is an opportunity to charge the EREV, notifying, using the user interface, a user of the opportunity; c) receiving one or more user commands; and d) based on the one or more user commands, performing one or more charging functions of the EREV.

In certain preferred methods the EREV is configured to i) perform using all wheel rive (AWD) when the battery is not charging, and ii) not perform AWD when the battery is charging. In certain preferred methods, when there is an opportunity to charge the EREV suggest one or more user commands for charging the vehicle. In certain preferred methods, the power generation unit is an internal combustion engine (ICE). Other preferred and suitable power generation units include e.g. a fuel cell. In preferred aspects, the computing device suitably further comprises a user interface such as a graphical user interface.

According to an exemplary embodiment, the method may comprise, when there is an opportunity to charge the EREV, receiving one or more user data inputs, and, based on the one or more vehicle data inputs and the one or more user data inputs, generating a pre-charge AWD range estimation of the EREV and a post-charging AWD range estimation of the EREV.

According to an exemplary embodiment, the one or more user data inputs may comprise one or more of the following: one or more vehicle usage patterns; previous visit to a location data;

frequency information on the location; typical location duration; user calendar and schedule data; and navigation destination information data.

According to an exemplary embodiment, the method may comprise receiving, via the graphical user interface, the one or more user data inputs.

According to an exemplary embodiment, the one or more vehicle data inputs may comprise one or more of the following: a vehicle location; one or more hardware conditions; a fuel level; a distance to a fueling location; a state of charge (SOC) of the battery; a closure status of the EREV; a charging status of the EREV; a towing status of the EREV; one or more ambient conditions; navigation data; expected duration data; advanced driver assistance systems (ADAS) data; and user history data.

According to an exemplary embodiment, the one or more user commands may comprise a command to charge the battery, and the one or more charging functions may comprise charging the battery.

According to an exemplary embodiment, the method may comprise determining, using the computing device, whether one or more set charging thresholds have been reached.

According to an exemplary embodiment, the method may comprise, when the one or more set charging thresholds have been reached, cancelling a charge function.

According to an exemplary embodiment, the one or more set charging thresholds may comprise one or more of the following: a set target SOC of the battery; and a distance to empty (DTE) of the EREV.

According to an exemplary embodiment, the method may comprise, when there is not a charging opportunity, notifying, using the graphical user interface, the user of the lack of charging opportunity.

According to an object of the present disclosure, a system for performing smart remote charging of an EREV is provided. The system may comprise an EREV. The EREV may comprise a battery, one or more onboard MGUs, a power generation unit configured to charge the battery, utilizing the one or more MGUs, and a computing device, comprising a processor, a memory, and a user interface. The EREV may be configured to perform using AWD when the battery is not charging, and not perform AWD when the battery is charging. The memory may be configured to store instructions that, when executed by the processor, are configured to cause the processor to receive one or more vehicle data inputs from an EREV, determine, using the processor, whether there is an opportunity to charge the EREV, when there is an opportunity to charge the EREV, notify, using the graphical user interface, a user of the opportunity and suggest one or more user commands for charging the vehicle, receive one or more user commands, and, based on the one or more user commands, perform one or more charging functions of the EREV.

In certain preferred methods, the power generation unit is an internal combustion engine (ICE). Other preferred and suitable power generation units include e.g. a fuel cell. In certain preferred aspects, the user interface may be a graphical user interface.

According to an exemplary embodiment, the programming instructions, when executed by the processor, may be configured to cause the processor to, when there is an opportunity to charge the EREV, receive one or more user data inputs, and, based on the one or more vehicle data inputs and the one or more user data inputs, generate a pre-charge AWD range estimation of the EREV and a post-charging AWD range estimation of the EREV.

According to an exemplary embodiment, the one or more user data inputs may comprise one or more of the following: one or more vehicle usage patterns; previous visit to a location data; frequency information on the location; typical location duration; user calendar and schedule data; and navigation destination information data.

According to an exemplary embodiment, the programming instructions, when executed by the processor, may be configured to cause the processor to receive, via the graphical user interface, the one or more user data inputs.

According to an exemplary embodiment, the one or more vehicle data inputs may comprise one or more of the following: a vehicle location; one or more hardware conditions; a fuel level; a distance to a fueling location; an SOC of the battery; a closure status of the EREV; a charging status of the EREV; a towing status of the EREV; one or more ambient conditions; navigation data; expected duration data; ADAS data; and user history data.

According to an exemplary embodiment, the one or more user commands may comprise a command to charge the battery, and the one or more charging functions may comprise charging the battery.

According to an exemplary embodiment, the programming instructions, when executed by the processor, may be configured to cause the processor to determine whether one or more set charging thresholds have been reached.

According to an exemplary embodiment, the programming instructions, when executed by the processor, may be configured to cause the processor to, when the one or more set charging thresholds have been reached, cancel a charge function.

According to an exemplary embodiment, the one or more set charging thresholds may comprise one or more of the following: a set target SOC of the battery; and a DTE of the EREV.

According to an exemplary embodiment, the programming instructions, when executed by the processor, may be configured to cause the processor to, when there is not a charging opportunity, notify, using the graphical user interface, the user of the lack of charging opportunity.

In further aspects, vehicles are provided that comprise a system as disclosed herein.

### BRIEF DESCRIPTION OF THE DRAWINGS

The accompanying drawings, which are incorporated in and form a part of the Detailed Description, illustrate various non-limiting and non-exhaustive embodiments of the subject matter and, together with the Detailed Description, serve to explain principles of the subject matter discussed below. Unless specifically noted, the drawings referred to in this Brief Description of Drawings should be understood as not being drawn to scale and like reference numerals refer to like parts throughout the various figures unless otherwise specified.

FIG. 1 illustrates an extended range electric vehicle (EREV) configured to perform smart remote charging, according to an exemplary embodiment of the present disclosure.

FIGS. 2A-B illustrates a flowchart of a method for performing smart remote charging of an EREV, according to an exemplary embodiment of the present disclosure.

FIG. 3 illustrates an example architecture of a vehicle, according to an exemplary embodiment of the present disclosure.

FIG. 4 illustrates example elements of a computing device, according to an exemplary embodiment of the present disclosure.

### DETAILED DESCRIPTION

The following Detailed Description is merely provided by way of example and not of limitation. Furthermore, there is no intention to be bound by any expressed or implied theory presented in the preceding background or in the following Detailed Description.

Reference will now be made in detail to various exemplary embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included within the spirit and scope of the various embodiments as defined by the appended claims. Furthermore, in this Detailed Description, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

It should be borne in mind, however, that these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “communicating,” “taking,” “comparing,” “monitoring,” “calibrating,” “estimating,” “initiating,” “providing,” “receiving,” “controlling,” “transmitting,” “isolating,” “generating,” “aligning,” “synchronizing,” “identifying,” “maintaining,” “displaying,” “switching,” or the like, refer to the actions and processes of an electronic item such as: a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In aspects, a vehicle may comprise an internal combustion engine system as disclosed herein.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example device vibration sensing system and/or electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration. One or more components of an SPU or electronic device described herein may be embodied in the form of one or more of a “chip,” a “package,” an Integrated Circuit (IC).

According to exemplary embodiments, systems and methods for performing extended range electric vehicle (EREV) smart remote charging are provided.

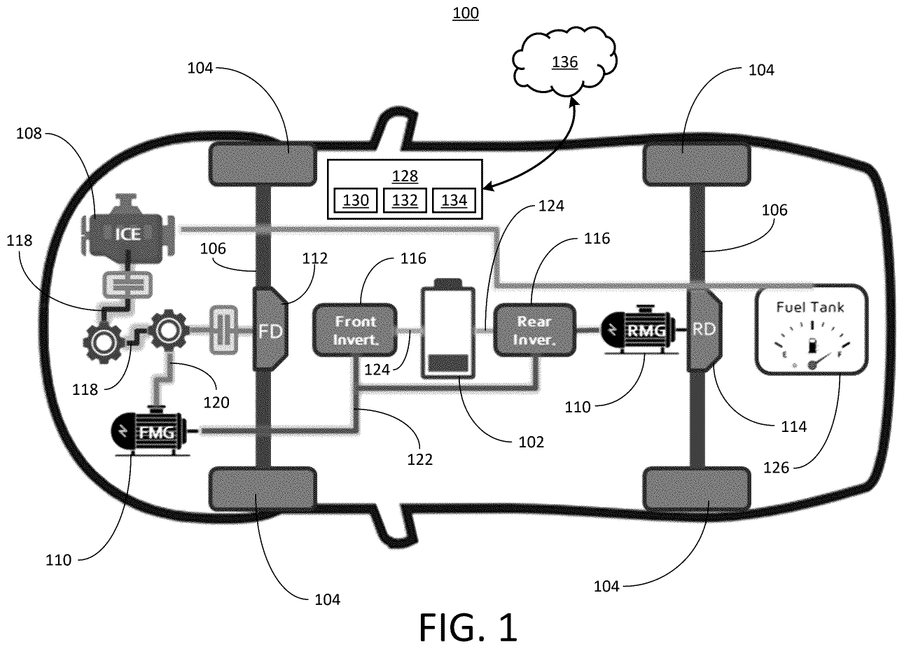

Referring now to FIG. 1, an EREV 100 configured to perform smart remote charging is illustratively provided, in accordance with an exemplary embodiment of the present disclosure.

A traditional or regular series hybrid layout utilizes two motors, including one motor for charging and motor one for driving the wheels. There is an additional cost to have a motor only serve one purpose instead of acting as both a motor and a generator, like a traditional parallel hybrid or EV layout.

According to an exemplary embodiment, the EREV 100 may comprise a high voltage battery 102, a plurality of wheels 104, one or more axles 106 coupled to the one or more wheels 104, a power generation unit such as an internal combustion engine (ICE) or fuel cell 108, and/or an onboard motor generator unit (MGU) 110 (e.g., a front MGU (FMG), a rear MGU (RMG), etc.). According to an exemplary embodiment, the power generation unit 108 may be configured to charge the battery 102 but not power the wheels 104.

According to an exemplary embodiment, when a state of charge (SOC) of the battery 102 is low, the ICE 108 may be configured to charge the battery 102 utilizing one or more onboard MGUs 110.

The EREV 100 may be configured to perform using all wheel drive (AWD), incorporating a front drive motor 112 and a rear drive motor 114. According to an exemplary embodiment, due to the unique cost-efficient layout of the power generation unit 108 and the motors 112, 114, the EREV 100 may lose AWD functionality while the battery 102 is charging. For example, when the front drive motor 112 is utilized for charging, the EREV 100 may disconnect the front drive motor 112 via a clutch from torque output to the wheels 104 to an inverter 116 (e.g., a front inverter, rear inverter, etc.) coupled to the battery 102. The EREV 100 may comprise one or more inverters 116.

According to an exemplary embodiment, the power generation unit (e.g. ICE) 108 may be configured to generate one-directional torque 118, bi-directional torque 120, etc. According to an exemplary embodiment, the one or more onboard MGUs 110 may be configured to generate bi-directional AC power 122, and the one or more inverters 116 may be configured to generate bi-directional DC power 124.

According to an exemplary embodiment, the power generation unit (e.g. ICE) 108 may be powered by fuel (e.g., gasoline, diesel fuel, and/or other suitable fuel) stored in a fuel tank 126.

According to an exemplary embodiment, the EREV 100 may comprise a computing device 128. The computing device 128 may comprise a processor 130, a memory 132, and/or a user interface 134 (e.g., a graphical user interface). The computing device 128 may be configured to send and/or receive commands/data/input/etc. via one or more external systems via wired and/or wireless connection (e.g., via the cloud 136).

The memory 132 may be configured to store programming instructions that, when executed by the processor 130, may be configured to cause the processor 130 to perform one or more tasks such as, e.g., utilizing user and vehicle data to optimally suggest remote charging of the HV battery 102 with the onboard power generation unit (e.g. ICE) 108 and MGU 110, and/or performing one or more other suitable tasks. According to an exemplary embodiment, the front MGU 108 (the FMG) may be configured to serve dual purposes as an AWD motor and a generator.

The more HV battery 102 charge available, the more available range the EREV 100 has with AWD. This, in turn, increases vehicle performance of the EREV 100.

For example, a user may park their AWD EREV 100 at any location, such as, e.g., a store, park, or gas/charge station and, while there, data may be collected from the EREV 100 as input to logic and stored in the memory 132. According to an exemplary embodiment, the programmable instructions may be configured to cause the processor 130 to analyze vehicle data and determine if there is an opportunity to charge the HV battery 102. Charging the HV battery 102 increases the amount of time that the user can use the AWD feature of the EREV 100 with the front MGU 110.

According to an exemplary embodiment, when the processor 130 determines that there is an opportunity to charge the HV battery 102, the programming instructions may be configured to cause the processor 130 to receive and analyze additional user data input to further refine the battery 102 charge determination and generate pre-and post-charging AWD range estimations.

According to an exemplary embodiment, when the processor 130 determines that there is an opportunity to charge the HV battery 102, an indication is given to the user (e.g., via the graphical user interface 134). According to an exemplary embodiment, when the processor 130 determines that there is not an opportunity to charge the HV battery 102, a reason why there is not an opportunity may be displayed (e.g., via the graphical user interface 134) but, in this instance, there is no pop-up suggestion to charge the battery 102.

According to an exemplary embodiment, the programmable instructions may be configured to cause the processor 130 to, after reviewing data and suggestion from the logic, receive input from the user initiating or alternatively ending/declining battery 102 charging and proceeding in accordance with the user input (e.g., charging the battery 102 when the user initiates battery 102 charging). According to an exemplary embodiment, a user may utilize in-vehicle controls, a mobile vehicle application, and/or other remote such as, e.g., a key-fob or activewear, to activate the charging of the battery 102. According to an exemplary embodiment, the programmable instructions may be configured to cause the processor 130 to receive user input setting a user's own charging target amounts based on e.g., duration or miles According to an exemplary embodiment, the programmable instructions may be configured to cause the processor 130 to cause the EREV 100 to charge the HV battery 102 according to the logic predetermination until a set target SOC and/or distance to empty (DTE) are reached.

According to an exemplary embodiment, a charge function may be cancelled by either target completion or user deactivation.

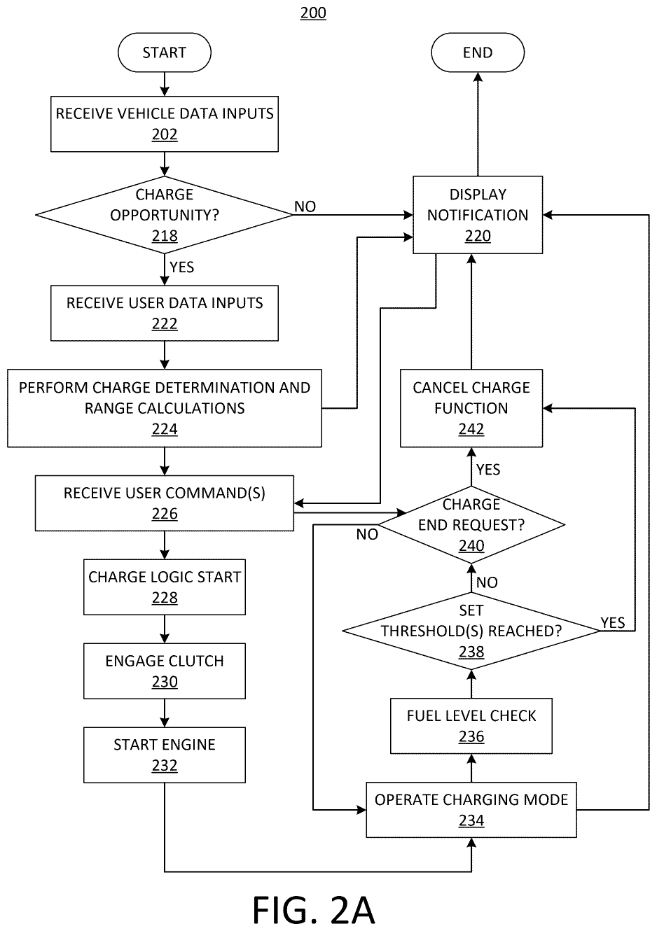

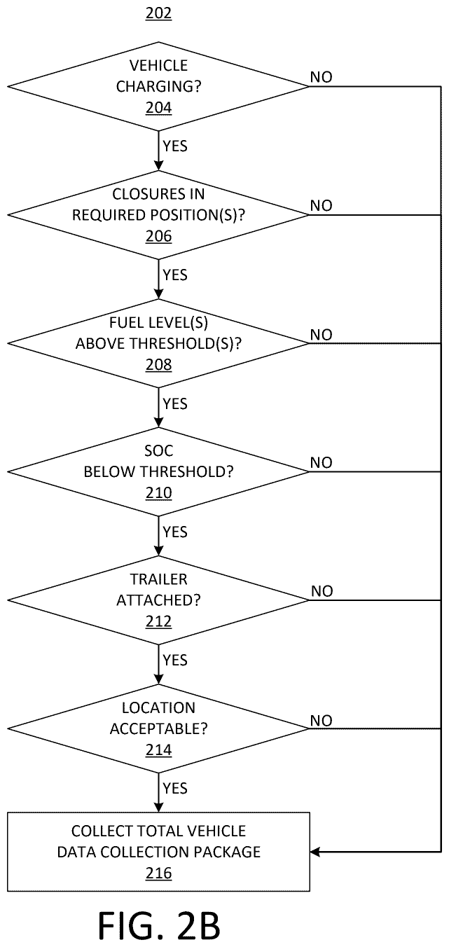

Referring now to FIGS. 2A-2B, a flowchart of a method 200 for performing smart remote charging of an EREV is illustratively provided, in accordance with an exemplary embodiment of the present disclosure.

Using one or more sensors of the EREV, one or more vehicle data inputs, at 202, may be received. According to an exemplary embodiment, a user parks their AWD EREV at any location, such as a store, park, or gas/charge station, and the data may be collected from the vehicle as the vehicle data inputs.

The vehicle data inputs may comprise a vehicle location, hardware conditions, a fuel level, a distance to a fueling location, an SOC, a closure status of the vehicle, a charging status of the vehicle, a towing status of the vehicle, weather information/ambient conditions, navigation data, expected duration data, advanced driver assistance systems (ADAS) data (e.g., camera data, LiDAR data, radar data, etc.), user history data, and/or other suitable vehicle data.

An example of the receiving the one or more vehicle data inputs is shown, e.g., in FIG. 2B. In this example, a common use case for the EREV is shown and described, where the user is visiting a frequently visited place such as, e.g., a preferred favorite grocery store. According to an exemplary embodiment, the processor of the EREV may be configured to collect data from various logic modules and/or other data sources throughout the vehicle. These sources may comprise, e.g., a battery control module, a fuel level sensor, a body control module, ADAS camera information, navigation location information, and/or other suitable sources.

The memory of the computing device of the EREV may be configured to store programming instructions that, when executed by the processor, may be configured to cause the processor to perform one or more tasks. These tasks may comprise going through a string of yes-no gates to determine if vehicle conditions are correct.

Regardless of a yes or no logic check, all information from the vehicle (e.g., the EREV) may be collected, at 216, in a status data package, which may be passed on to the remainder of the logic for UI display or other determinations.

According to an exemplary embodiment, it may be determined, at 204, whether the EREV is charging. Charging the vehicle increases the amount of time the user can use the AWD feature with the front MGU. When the vehicle is not charging, then, at 216, the vehicle information may be collected in the status data package. When the vehicle is charging, another in the string of yes-no gates may be determined.

According to an exemplary embodiment, it may be determined, at 206, whether there are any closures in one or more required positions. For example, it may be determined whether all doors, the trunk, the hood, the gas cap cover, and/or any other closures are properly in the closed position. When all the closures are not in the closed position, then, at 216, the vehicle information may be collected in the status data package. When all closured are in the closed position, another in the string of yes-no gates may be determined.

According to an exemplary embodiment, it may be determined, at 208, whether the fuel level is above a threshold (e.g., above a minimum percentage of capacity). When the fuel level is not above the threshold, then, at 216, the vehicle information may be collected in the status data package. When the fuel level is above the threshold, another in the string of yes-no gates may be determined.

According to an exemplary embodiment, at 210, it may be determined whether an SOC of the vehicle battery is below a threshold (e.g., below a minimum percentage of capacity). When the battery SOC is not below the threshold, then, at 216, the vehicle information may be collected in the status data package. When the battery SOC is below the threshold, another in the string of yes-no gates may be determined.

According to an exemplary embodiment, at 212, it may be determined whether a trailer is attached to the vehicle. If there is a trailer, the charge potential increases. If there is no trailer, there are still many instances where charging may be appropriate. When there is no trailer attached to the vehicle, then, at 216, the vehicle information may be collected in the status data package. When there is a trailer attached to the vehicle, another in the string of yes-no gates may be determined.

According to an exemplary embodiment, at 214, it may be determined whether a location is acceptable. According to an exemplary embodiment, certain locations may not apply for charging, such as, e.g., service stations, gas stations, and/or other pre-determined quick-stop locations. According to an exemplary embodiment, whether or not the location is acceptable, this vehicle information, at 216, may be collected in the status data package.

According to an exemplary embodiment, a charge opportunity indication may be passed out of the total vehicle data collection package and, at 218, it may be determined whether there is a charge opportunity.

According to an exemplary embodiment, based on the vehicle data inputs, when there is not a charging opportunity, then, at 220, a notification of the lack of a charging opportunity may be displayed, using a graphical user interface, but there is no pop-up suggestion to charge the vehicle.

When there is a charging opportunity, then, at 222, one or more additional user data inputs may be received. The one or more additional user data inputs may comprise, but are not limited to, vehicle usage patterns (e.g., frequent usage, drive modes, driving style, etc.), previous visit(s) to location data, frequency information on the location from user data, typical location duration from user and map data, user calendar and schedule data, navigation destination information data, and/or other suitable user data inputs.

According to an exemplary embodiment, the one or more additional user data inputs may be collected from the user via a graphical user interface and/or other suitable means. The one or more additional user data inputs may come from vehicle usage patterns, location history location frequency, location duration history, ADAS camera information, navigation destination information, and/or other suitable sources.

According to an exemplary embodiment, usage amount, drive modes, and driving style all may affect logic. For example, snow mode, AWD “lock,” sport mode, and aggressive driver learning, among others, are all examples that may increase the chance of a charge suggestion.

According to an exemplary embodiment, a frequently visited location may prompt the processor to collect user location history data. When the user has never visited the location, then other user data from a data aggregate source may utilized.

According to an exemplary embodiment, the processor may be configured to check previous history data to determine an expected duration of a visit. When the duration is short, then charging may not be suggested, and longer durations may improve chances of suggesting charging.

According to an exemplary embodiment, a user calendar may provide additional information about the timeline at the stopped location, of where the user is headed next, and whether AWD may be needed to get to the next location.

According to an exemplary embodiment, the navigation information may be used to expand on driver intent. For example, when there is nothing in the user's calendar, the navigation information may indicate that the next location is a charging location, and, if home is the next destination, it may be expected that charging may occur at home.

According to an exemplary embodiment, the one or more additional user data inputs may be received to further refine the charge determination and generate pre-and post-charging AWD range estimations, at 224. When a charge is determined, then, at 220, a notification may be displayed to the user via a graphical user interface and/or other suitable means. When no charge is determined, then, at 220, a reason why there is no charge may displayed, but there is no pop-up suggestion to charge the vehicle.

According to an exemplary embodiment, at 226, after reviewing data and one or more suggestions, the user may input one or more user commands. According to an exemplary embodiment, the notification displayed, at 220, may display one or more suggestions for one or more user commands.

The one or more user commands may initiate or alternatively end/decline battery charging. The one or more user commands may be input from a vehicle application interface, a vehicle user interface, a key fob, one or more wearable devices, and/or other suitable means. According to an exemplary embodiment, the one or more user commands may set one or more personalized charging target amounts based on duration or miles.

According to an exemplary embodiment, when the one or more user commands indicate vehicle charging, then, at 228, charge logic may start, a clutch may be engages, at 230, the engine may start, at 232, and a charging mode may be operated, at 234. According to an exemplary embodiment, when then charging mode is operated, a notification of the same may be displayed to the user, at 220, and a fuel level check may be performed, at 236. According to an exemplary embodiment, the vehicle may charge the HV battery according to the logic predetermination until one or more set charge thresholds (e.g., a set target SOC, a distance to empty (DTE), and/or other suitable thresholds) are reached.

At 238, it may be determined whether the set charge thresholds have been met. When the set charge thresholds have not been reached, then, at 240, it may be determined whether there is a charging end request. According to an exemplary embodiment, it may be determined whether there is a charge end request in response to the user command input, at 226.

When there is a charge end request, then, at 242, a charge function may be cancelled, and a user notified, at 220. According to an exemplary embodiment, when the set charge thresholds have been reached, then, at 242, a charge function may be cancelled, and a user notified, at 220.

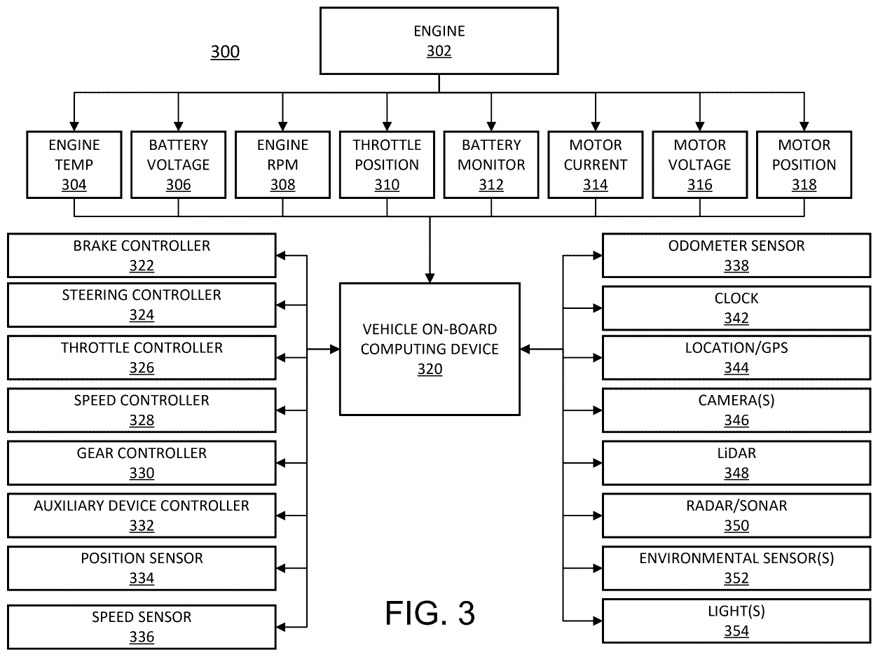

Referring now to FIG. 3, an example vehicle system architecture 300 for a vehicle is provided, in accordance with an exemplary embodiment of the present disclosure. The following discussion of vehicle system architecture 300 is sufficient for understanding one or more components of EREV 100.

As shown in FIG. 3, the vehicle system architecture 300 may comprise an engine, motor or propulsive device 302 and various sensors 304-318 for measuring various parameters of the vehicle system architecture 300 (e.g., the vehicle data inputs). In gas-powered or hybrid vehicles having a fuel-powered engine, the sensors 304-318 may comprise, for example, an engine temperature sensor 304, a battery voltage sensor 306, an engine Rotations Per Minute (RPM) sensor 308, and/or a throttle position sensor 310. If the vehicle is an electric or hybrid vehicle, then the vehicle may comprise an electric motor, and accordingly may comprise sensors such as a battery monitoring system 312 (to measure current, voltage and/or temperature of the battery), motor current 314 and voltage 316 sensors, and motor position sensors such as resolvers and encoders 318.

Operational parameter sensors that are common to both types of vehicles may comprise, for example: a position sensor 334 such as an accelerometer, gyroscope and/or inertial measurement unit; a speed sensor 336; and/or an odometer sensor 338. The vehicle system architecture 300 also may comprise a clock 342 that the system uses to determine vehicle time and/or date during operation. The clock 342 may be encoded into the vehicle on-board computing device 620, it may be a separate device, or multiple clocks may be available.

The vehicle system architecture 300 may comprise various sensors that operate to gather information about the environment in which the vehicle is traveling. These sensors may comprise, for example: a location sensor 344 (for example, a Global Positioning System (GPS) device); object detection sensors such as one or more cameras 346; a LiDAR sensor system 348; and/or a radar and/or a sonar system 350. The sensors may comprise environmental sensors 352 such as, e.g., a humidity sensor, a precipitation sensor, a light sensor, and/or ambient temperature sensor. The object detection sensors may be configured to enable the vehicle system architecture 300 to detect objects that are within a given distance range of the vehicle in any direction, while the environmental sensors 352 may be configured to collect data about environmental conditions within the vehicle's area of travel. According to an exemplary embodiment, the vehicle system architecture 300 may comprise one or more lights 354 (e.g., headlights, flood lights, flashlights, etc.).

During operations, information may be communicated from the sensors to an on-board computing device 320 (e.g., computing device 128, computing device 400). The on-board computing device 320 may be configured to analyze the data captured by the sensors and/or data received from data providers and may be configured to optionally control operations of the vehicle system architecture 300 based on results of the analysis. For example, the on-board computing device 320 may be configured to control: braking via a brake controller 322; direction via a steering controller 324; speed and acceleration via a throttle controller 326 (in a gas-powered vehicle) or a motor speed controller 328 (such as a current level controller in an electric vehicle); a differential gear controller 330 (in vehicles with transmissions); and/or other controllers. The brake controller 322 may comprise a pedal effort sensor, pedal effort sensor, and/or simulator temperature sensor, as described herein.

Geographic location information may be communicated from the location sensor 344 to the on-board computing device 320, which may then access a map of the environment that corresponds to the location information to determine known fixed features of the environment such as streets, buildings, stop signs and/or stop/go signals. Captured images from the cameras 346 and/or object detection information captured from sensors such as LiDAR 348 may be communicated from those sensors to the on-board computing device 320. The object detection information and/or captured images may be processed by the on-board computing device 320 to detect objects in proximity to the vehicle. Any known or to be known technique for making an object detection based on sensor data and/or captured images may be used in the embodiments disclosed in this document.

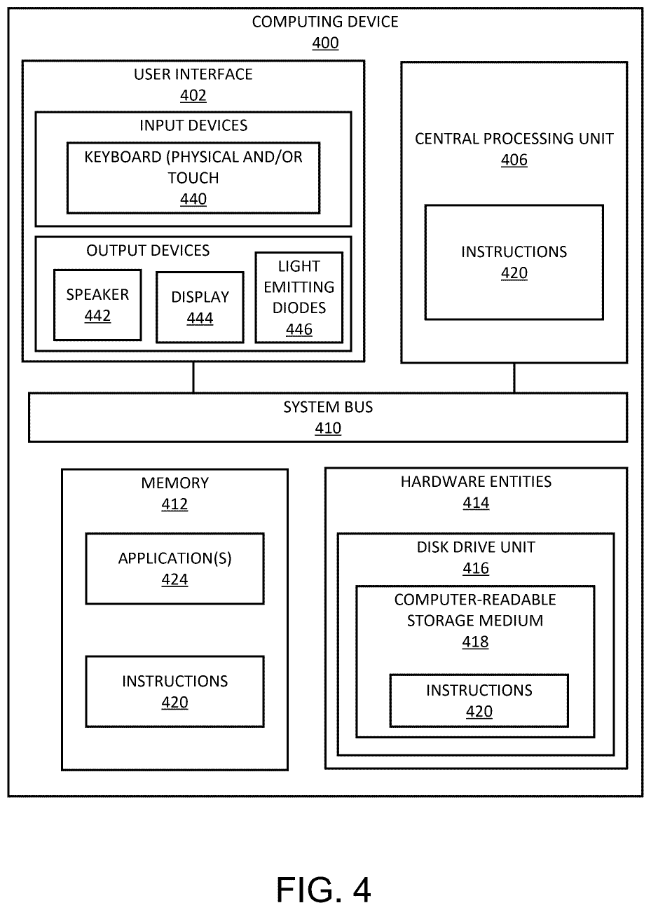

Referring now to FIG. 4, an illustration of an example architecture for a computing device 400 is provided. According to an exemplary embodiment, one or more functions of the present disclosure may be implemented by a computing device such as, e.g., computing device 400 or a computing device similar to computing device 400. Computing device 400 may be a quantum computer, a classical computer, and/or have one or more components configured to perform one or more quantum and/or classical computing functions. Computing device 128 and/or computing device 320 may be an example of computing device 400 and/or may comprise one or more components of computing device 400.

The hardware architecture of FIG. 4 represents one example implementation of a representative computing device configured to implement at least a portion of the systems/devices (e.g., EREV 100) and method(s)/control logic(s) (e.g., method 200) described herein.

Some or all components of the computing device 400 may be implemented as hardware, software, and/or a combination of hardware and software. The hardware may comprise, but is not limited to, one or more electronic circuits. The electronic circuits may comprise, but are not limited to, passive components (e.g., resistors and capacitors) and/or active components (e.g., amplifiers and/or microprocessors). The passive and/or active components may be adapted to, arranged to, and/or programmed to perform one or more of the methodologies, procedures, or functions described herein.

As shown in FIG. 4, the computing device 400 may comprise a user interface 402 (e.g., a graphical user interface), a Central Processing Unit (“CPU”) 406, a system bus 410, a memory 412 connected to and accessible by other portions of computing device 400 through system bus 410, and hardware entities 414 connected to system bus 410. The user interface may comprise input devices and output devices, which may be configured to facilitate user-software interactions for controlling operations of the computing device 400. The input devices may comprise, but are not limited to, a physical and/or touch keyboard 740. The input devices may be connected to the computing device 400 via a wired or wireless connection (e.g., a Bluetooth® connection). The output devices may comprise, but are not limited to, a speaker 442, a display 444, and/or light emitting diodes 446.

At least some of the hardware entities 414 may be configured to perform actions involving access to and use of memory 412, which may be a Random Access Memory (RAM), a disk driver and/or a Compact Disc Read Only Memory (CD-ROM), among other suitable memory types. Hardware entities 414 may comprise a disk drive unit 416 comprising a computer-readable storage medium 418 on which may be stored one or more sets of instructions 420 (e.g., programming instructions such as, but not limited to, software code) configured to implement one or more of the methodologies, procedures, or functions described herein. The instructions 420 may also reside, completely or at least partially, within the memory 412 and/or within the CPU 406 during execution thereof by the computing device 400.

The memory 412 and the CPU 406 may also constitute machine-readable media. The term “machine-readable media”, as used here, refers to a single medium or multiple media (e.g., a centralized or distributed database, and/or associated caches and servers) that store the one or more sets of instructions 420. The term “machine-readable media”, as used here, also refers to any medium that is capable of storing, encoding, or carrying a set of instructions 420 for execution by the computing device 400 and that cause the computing device 400 to perform any one or more of the methodologies of the present disclosure. According to various embodiments, one or more computer applications 424 may be stored on the memory 412.

What has been described above includes examples of the subject disclosure. It is, of course, not possible to describe every conceivable combination of components or methodologies for purposes of describing the subject matter, but it is to be appreciated that many further combinations and permutations of the subject disclosure are possible. Accordingly, the claimed subject matter is intended to embrace all such alterations, modifications, and variations that fall within the spirit and scope of the appended claims.

In particular and in regard to the various functions performed by the above described components, devices, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter.

The aforementioned systems and components have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components. Any components described herein may also interact with one or more other components not specifically described herein.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Thus, the embodiments and examples set forth herein were presented in order to best explain various selected embodiments of the present invention and its particular application and to thereby enable those skilled in the art to make and use embodiments of the invention. However, those skilled in the art will recognize that the foregoing description and examples have been presented for the purposes of illustration and example only. The description as set forth is not intended to be exhaustive or to limit the embodiments of the invention to the precise form disclosed.

What is claimed is:

1. A method for performing smart remote charging of an extended range electric vehicle (EREV), comprising:
a) receiving, using a computing device, one or more vehicle data inputs from an EREV, the EREV comprising:
i) a battery;
ii) one or more onboard motor generator units (MGUs);
iii) a power generation unit configured to charge the battery, utilizing the one or more MGUs; and
iv) the computing device, comprising a processor and a memory;
b) determining, using the processor, whether there is an opportunity to charge the EREV;
c) when there is an opportunity to charge the EREV, notifying, using the user interface, a user of the opportunity;
d) receiving one or more user commands; and
e) based on the one or more user commands, performing one or more charging functions of the EREV.

2. The method of claim 1 wherein the EREV is configured to:
a) perform using all wheel drive (AWD) when the battery is not charging, and
b) not perform AWD when the battery is charging.

3. The method of claim 1 wherein when there is an opportunity to charge the EREV suggest one or more user commands for charging the vehicle

4. The method of claim 1 wherein the power generation unit is an internal combustion engine (ICE).

5. The method of claim 1, further comprising:
a) when there is an opportunity to charge the EREV, receiving one or more user data inputs; and
b) based on the one or more vehicle data inputs and the one or more user data inputs, generating a pre-charge AWD range estimation of the EREV and a post-charging AWD range estimation of the EREV.

6. The method of claim 5, wherein the one or more user data inputs comprise one or more of the following:
a) one or more vehicle usage patterns;
b) previous visit to a location data;
c) frequency information on the location;
d) typical location duration;
e) user calendar and schedule data; and
f) navigation destination information data.

7. The method of claim 5, further comprising receiving, via the graphical user interface, the one or more user data inputs.

8. The method of claim 1, wherein the one or more vehicle data inputs comprise one or more of the following:
a) a vehicle location;
b) one or more hardware conditions;
c) a fuel level;
d) a distance to a fueling location;
e) a state of charge (SOC) of the battery;
f) a closure status of the EREV;
g) a charging status of the EREV;
h) a towing status of the EREV;
i) one or more ambient conditions;
j) navigation data;
k) expected duration data;
l) advanced driver assistance systems (ADAS) data; and
m) user history data.

9. The method of claim 1, wherein:
a. the one or more user commands comprise a command to charge the battery, and the one or more charging functions comprises charging the battery.

10. The method of claim 9, further comprising determining, using the computing device, whether one or more set charging thresholds have been reached.

11. The method of claim 10, further comprising, when the one or more set charging thresholds have been reached, cancelling a charge function.

12. The method of claim 10, wherein the one or more set charging thresholds comprise one or more of the following:
a) a set target state of charge (SOC) of the battery; and
b) a distance to empty (DTE) of the EREV.

13. The method of claim 1, further comprising, when there is not a charging opportunity, notifying, using the graphical user interface, the user of the lack of charging opportunity.

14. A system for performing smart remote charging of an extended range electric vehicle (EREV), comprising:
an EREV, comprising:
i) a battery;
ii) one or more onboard motor generator units (MGUs);
iii) a power generation unit configured to charge the battery, utilizing the one or more MGUs, and
iv) a computing device comprising a processor and a memory,
v) wherein the memory is configured to store instructions that, when executed by the processor, are configured to cause the processor to:
a) receive one or more vehicle data inputs from an EREV;
b) determine, using the processor, whether there is an opportunity to charge the EREV;
c) when there is an opportunity to charge the EREV, notify, using the graphical user interface;
d) receive one or more user commands; and
e) based on the one or more user commands, perform one or more charging functions of the EREV.

15. The system of claim 14, wherein the programming instructions, when executed by the processor, are further configured to cause the processor to:
a) when there is an opportunity to charge the EREV, receive one or more user data inputs; and
b) based on the one or more vehicle data inputs and the one or more user data inputs, generate a pre-charge AWD range estimation of the EREV and a post-charging AWD range estimation of the EREV.

16. The system of claim 15, wherein the one or more user data inputs comprise one or more of the following:
a) one or more vehicle usage patterns;
b) previous visit to a location data;
c) frequency information on the location;
d) typical location duration;
e) user calendar and schedule data; and
f) navigation destination information data.

17. The system of claim 14, wherein the one or more vehicle data inputs comprise one or more of the following:
a) a vehicle location;
b) one or more hardware conditions;
c) a fuel level;
d) a distance to a fueling location;
e) a state of charge (SOC) of the battery;
f) a closure status of the EREV;
g) a charging status of the EREV;
h) a towing status of the EREV;
i) one or more ambient conditions;
j) navigation data;
k) expected duration data;
l) advanced driver assistance systems (ADAS) data; and
m) user history data.

18. The system of claim 14, wherein:
a) the one or more user commands comprise a command to charge the battery, and
b) the one or more charging functions comprises charging the battery.

19. The system of claim 14, wherein the programming instructions, when executed by the processor, are further configured to cause the processor to, when there is not a charging opportunity, notify, using the user interface, the user of the lack of charging opportunity.

20. A vehicle comprising the system of claim 14.
